(19) United States
(12) Patent Application Publication
(10) Pub. No.: US 2002/0087938 A1
(43) Pub. Date: Jul. 4, 2002

(54) Automated memory design system

(76) Inventors: Victor Gutierrez de Dios, Fremont, CA (US); Michael J. Venditti JR., Cranford, NJ (US); Donald Dwight Mushinsky, Rockaway, NJ (US)

Correspondence Address: SAWYER LAW GROUP LLP, P.O. 51418, Palo Alto, CA, 94303, US

(21) Appl. No.: 09/750,476

(22) Filed: Dec. 28, 2000

(51) Int. Cl. G06F 17/50

(52) U.S. Cl. 716/2

(57) ABSTRACT

The present invention provides a method and system for automatically providing a memory system design. The method includes: (a) receiving memory system criteria; and (b) automatically extracting at least one memory system design based upon the memory system criteria. The present invention receives criteria which includes technical and market criteria. Based on these criteria, the present invention returns memory subsystem solutions. In the preferred embodiment, the solutions are selected from libraries of multiple memory type modules which use a single memory bus. If the solution does not exist in the libraries, a new solution is created. In this manner, the engineering time and resources required in designing the memory subsystem is reduced; a flexible memory system design is provided which addresses software development, obsolescence and market volatility problems; and a memory system design is provided which addresses the custom requirements of many different applications.

### FIELD OF THE INVENTION

The present invention relates to memories, and more particularly to the design of memory systems.

### BACKGROUND OF THE INVENTION

The design of a memory subsystem is an essential part of an embedded system. Conventionally, the design engineer manually selects the components according to the needs of the system's embedded applications. Once the components are selected, the design engineer manually designs the memory subsystem itself. This requires significant engineering time and resources.

In addition, this conventional method of memory subsystem design has several risks. First, the memory subsystem design depends on the development of custom software for the embedded system. Oftentimes, late software development leads to a compromised design of the memory subsystem. At other times, software is revised after beta shipments of the system requiring an expensive redesign of the whole hardware system to revise the memory subsystem design. This leads to late time to market. Avoiding redesign compromises the functions that the revised software provides and thus is not a proper solution.

Second, compromised memory subsystems or customized memory subsystems typically lead to obsolescence problems as memory devices move to higher bit capacities, different packages, and new specifications or interface standards. The average life of a memory device is usually shorter than the average life of the embedded system. In many instances, memory manufacturers are forced to build older devices which limit capacity growth.

Third, the eventual mass production of embedded systems is hampered by the volatility of prices and availability of memory devices. Carefully selecting products that adhere to the roadmap of memory manufacturers alleviates the problem slightly but usually not satisfactorily.

Accordingly, there exists a need for an automated memory design system. The automated memory design system should reduce the engineering time and resources required to design the memory subsystem of an embedded system, provide flexibility in the memory subsystem design which addresses software development, obsolescence and market volatility problems, and should address the custom requirements of many different applications.

### SUMMARY OF THE INVENTION

The present invention provides a method and system for automatically providing a memory system design. The method includes: (a) receiving memory system criteria; and (b) automatically extracting at least one memory system design based upon the memory system criteria. The present invention receives criteria which includes technical and market criteria. Based on these criteria, the present invention returns memory subsystem solutions. In the preferred embodiment, the solutions are selected from libraries of multiple memory type modules which use a single memory bus. If the solution does not exist in the libraries, a new solution is created. In this manner, the engineering time and resources required in designing the memory subsystem is reduced; a flexible memory system design is provided which addresses software development, obsolescence and market volatility problems; and a memory system design is provided which addresses the custom requirements of many different applications.

### BRIEF DESCRIPTION OF THE FIGURES

FIG. 1 is a block diagram illustrating a preferred embodiment of an automated memory design system in accordance with the present invention.

FIG. 2 is a block diagram illustrating a process flow of the automated memory design system in accordance with the present invention.

FIG. 3 illustrates a preferred embodiment of a memory system design library in accordance with the present invention.

FIGS. 4 and 5 illustrate a preferred embodiment of the single memory bus for the library of multiple memory type modules in accordance with the present invention.

FIG. 6 is a flow chart illustrating a preferred method of extraction of solutions in the automated memory design system in accordance with the present invention.

### DETAILED DESCRIPTION

The present invention provides an automated memory design system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

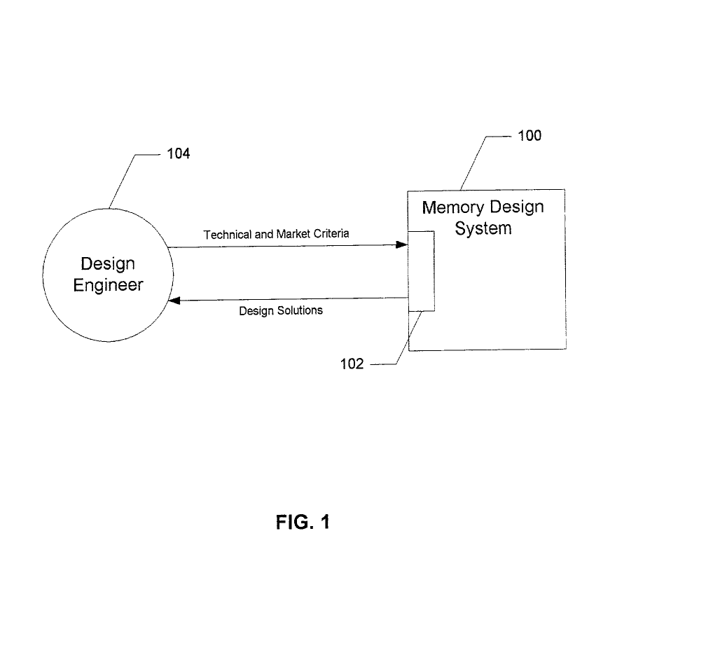

To more particularly describe the features of the present invention, please refer to FIGS. 1 through 6 in conjunction with the discussion below.

FIG. 1 is a block diagram illustrating a preferred embodiment of an automated memory design system in accordance with the present invention. The automated memory design system 100 accepts generalized or specific criteria from a design engineer 104 on relevant system and memory needs for an application and a description of relevant aspects of the embedded system. In the preferred embodiment, the design engineer 104 interacts with the system 100 via a user interface 102. The user interface 102 guides the design engineer 104 through the input of various criteria. The criteria can include both technical and market criteria. Technical criteria includes, but is not limited to, the memory types needed, the minimum and maximum capacities of each memory type, the data bus width of each memory type, etc. They can also include a description of the processing units, performance specifications, environmental requirements, physical constraints, etc. Market criteria includes, but is not limited to, price, availability, and upgradability of various components. Based on these criteria, the automated memory design system 100 returns one or more solutions to the design engineer 104 from which the design engineer 104 may choose.

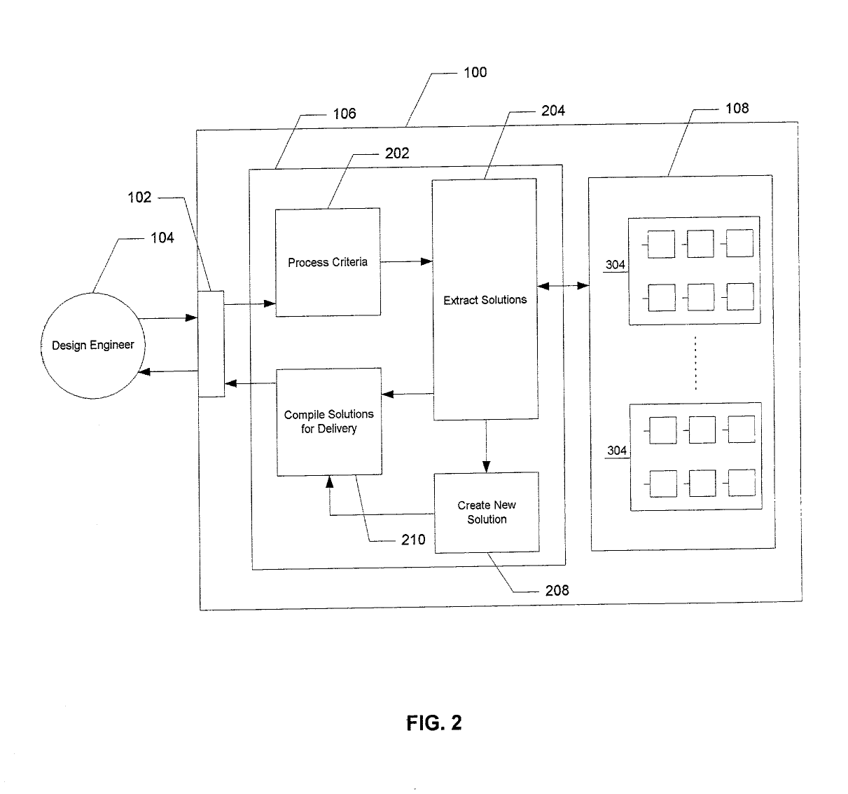

FIG. 2 is a block diagram illustrating a process flow of the automated memory design system 100 in accordance with the present invention. The preferred embodiment of the system 100 comprises the user interface 102, libraries 108 of memory system designs which use the same single memory bus 304, and a software 106 which extracts solutions and design tools, guides, and literature from the libraries 108. First, the design engineer 104 describes the embedded system, generalizes the memory needs, and inputs these criteria into the memory design system 100 via the user interface 102. The software 106 then processes the criteria, via step 202. The processing includes the performance of any required computations. It also includes the screening of the criteria received from the design engineer 104 for viability given the constraints of the embedded system, such as the specifications of its memory controller and processing unit, or the range of available specifications of a memory device type. Using the processed criteria, the software 106 next extracts the solutions, via step 204. In the preferred embodiment, the solutions are extracted from the libraries 108. If a possible solution does not exist in the libraries 108, then a new solution is created, via step 208. A new memory subsystem may be built based upon this new solution. Based on the extracted solutions, relevant and corresponding design tools, guides, and information will be compiled for delivery in the proper format, via step 210, to the design engineer 104 using the user interface 102.

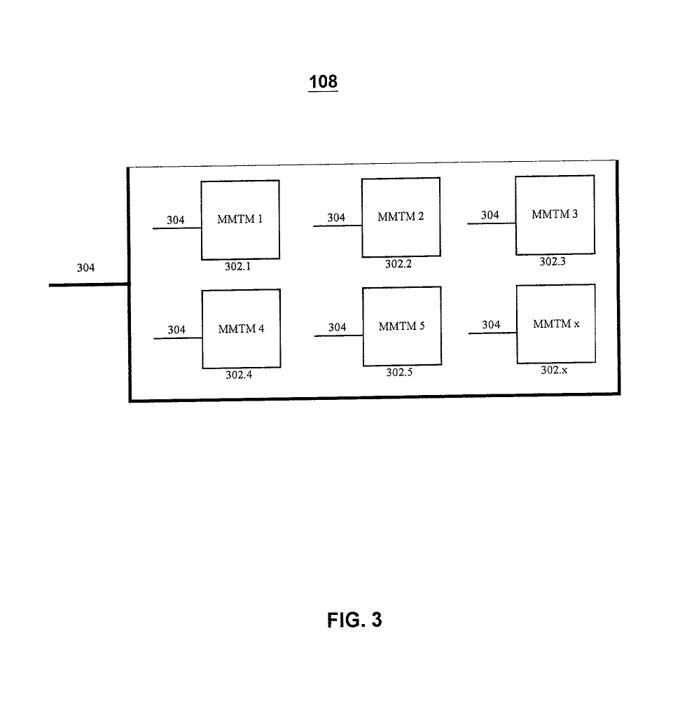

FIG. 3 illustrates a preferred embodiment of a memory system design library in accordance with the present invention. Each of the libraries 108 comprises a plurality of multiple memory type modules 302.1-302.x using the same single memory bus 304. The multiple memory type modules 302.1-302.x in each of the libraries 108 use the single memory bus 304 to communicate with a processor (not shown) of the embedded system. In the preferred embodiment, each multiple memory type module 302.1-302.x can be the whole or part of the memory subsystem for one or more embedded system applications. Each of the multiple memory type modules 302.1-302.x varies by the combination of memory capacities, memory subsystem architecture, and/or combinations of performance, power, and other specifications. The software 106 selects one or more of the modules 302.1-302.x as the memory subsystem design solutions which addresses the design engineer's criteria.

Selecting from a library of designs reduces the time and effort of designing the memory subsystem significantly.

The libraries 108 of multiple memory type modules is further described in co-pending U.S. patent application entitled “Library Of Multiple Memory Type Modules Using A Single Memory Bus”, Ser. No. (1928P), filed on______, assigned to the assignee of the present application. The preferred embodiment of the multiple memory-type module 302.1-302.x is further described in co-pending U.S. patent application entitled “Multiple Memory Type Module Using a Single Memory Bus”, Ser. No. (1926P), filed on ______,assigned to the assignee of the present application. Applicant hereby incorporates these applications by reference.

Each module 302.1-302.x can have a minimum of one or two devices per memory type, depending on the type, and thus provides greater granularity. It provides the benefits of memory modularity, where none was cost effective with the conventional memories, and leads to simpler design efforts because each uses the single memory bus 304. Each module 302.1-302.x also can be expanded from its minimum configuration.

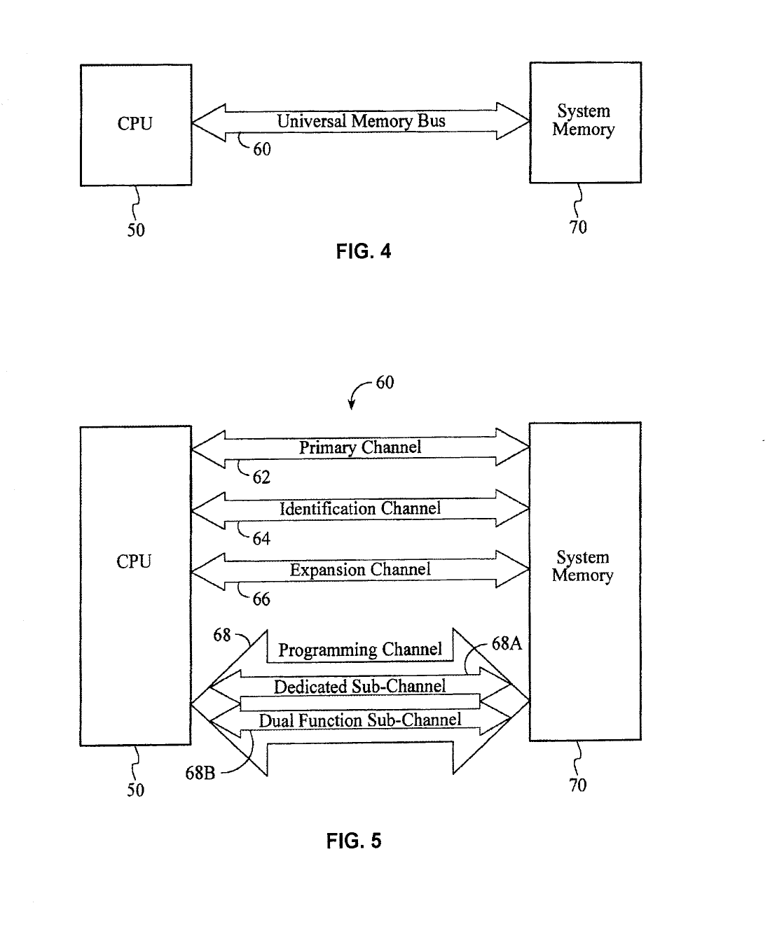

FIGS. 4 and 5 illustrate a preferred embodiment of the single memory bus for the library of multiple memory type modules in accordance with the present invention. FIG. 4 illustrates the architecture of the single memory bus in accordance with the present invention. The single memory bus 60 is for communicating data and providing programming access to the memory devices within the system memory 70. In the preferred embodiment, the system memory 70 is the multiple type memory module in accordance with the present invention. The single memory bus is disclosed in U.S. Pat. No. 6,067,593, filed on Jul. 18, 1997, issued on May 23, 2000, and assigned to the assignee of the present application. Applicant hereby incorporates this patent by reference. The term “single memory bus”, as used in this specification, is used interchangeably with the term “universal memory bus”, as used in U.S. Pat. No. 6,067,593.

FIG. 5 illustrates the channel architecture of the single memory bus in accordance with the present invention. The single memory bus 60 consists of a primary channel 62 for communicating boot data to activate a host system and normal data thereafter, an identification channel 64 for communicating data describing the device composition of the system memory 70, an expansion channel 66 for providing programming and data access to a memory device subsequently added to the system memory 70, and a programming channel 68 for providing programming access to each programmable memory device within the system memory 70. The primary channel 62 is generally comprised of power, address, data, and control lines which are necessary to establish a communication link between the central processing unit 60 (CPU) and the system memory 70. The identification channel 64 is generally composed of data and control lines for communicating identification data which describes the device composition of the system memory 70 to the host CPU 50. The expansion channel 66 is composed generally of additional data, address and/or programming lines which can be selectively activated to provide address, data, or programming signals to a subsequently added memory device. The programming channel 68 generally consists of lines which provide programming and control signals necessary to program the serial or parallel programmable memory devices resident within the system memory. In the preferred embodiment, the programming channel consists of a dedicated sub-channel 68A which is active only during programming operations and a dual function sub-channel 68B which communicates programming signals during programming operations while providing address, and or control signals during normal data transfer operations.

In this manner, the automated memory design system 100 in accordance with the present invention provides a design guide and tool to assist the design engineer 104 in developing comprehensive and riskless memory subsystem designs. The automated memory design system 100 significantly reduces the memory design effort of the design engineer 104. This saves valuable engineering time and resources which may be used for other more vital and complicated areas of the end product. The automated memory design system 100 also allows the design engineer 104 to quickly redesign the memory subsystem if changes in software requirements or hardware direction occur because a new solution is simply extracted from the libraries 108.

Although the present invention is described with the extraction of solutions from a library, one of ordinary skill in the art will understand that memory design solutions may be extracted from other forms of memory collections. Although the present invention is described with the library, the multiple memory type module, and the single memory bus above, one of ordinary skill in the art will understand that other types of memories and buses may be used. Although the present invention is described in the context of an embedded system, one of ordinary skill in the art will understand that the present invention may be applied to other systems with discreet components. These do not depart from the spirit and scope of the present invention.

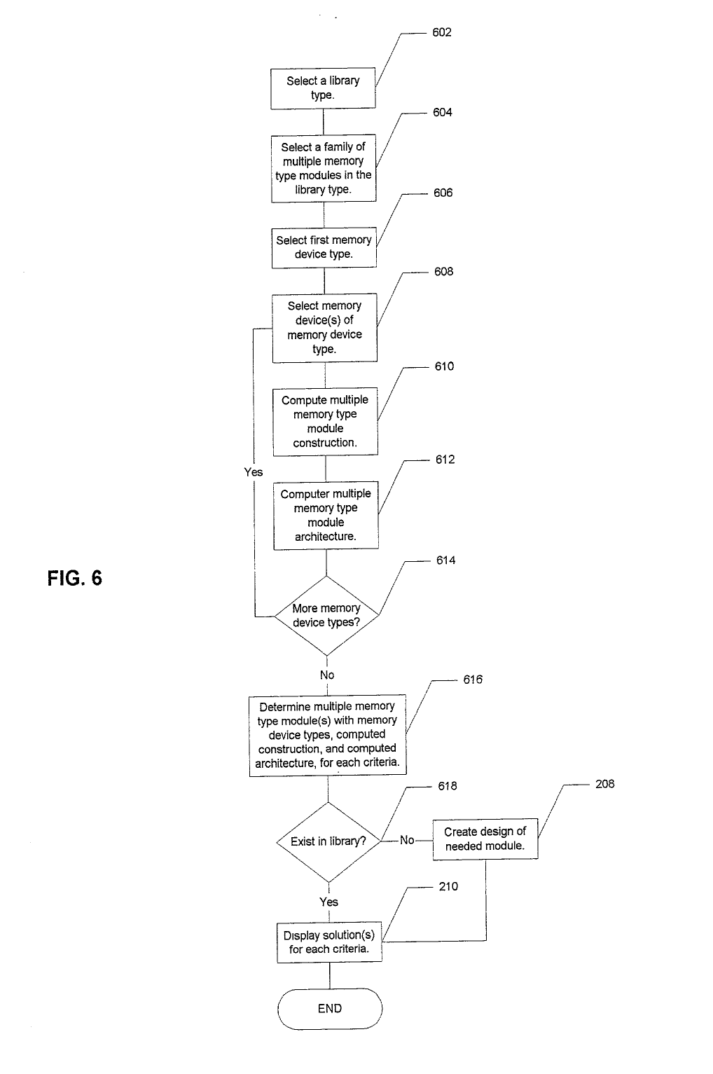

FIG. 6 is a flow chart illustrating a preferred method of extraction of solutions in the automated memory design system in accordance with the present invention. First, a library type is selected, via step 602, based upon the processed system information inputted by the design engineer 104. Example system information includes, but is not limited to, a data bus width, physical requirements, a processor, an external bus speed, and an operating temperature range. In the preferred embodiment, the selected library type has a maximum bus width, a form factor type, and a connector type which matches the system information. For illustrative purposes, assume that a library type with a 32-bit data bus, a small-outline dual in-line module (SODIMM) form factor, and a dynamic random access memory (DRAM) SODIMM connector is selected based upon the inputted criteria.

Next, a family of multiple memory type modules in the selected library type is selected, via step 604. A “family”, as used in this specification, refers to a particular combination of memory device types. Multiple memory type modules with the same combination of memory device types belong in the same family. The family of multiple memory type modules is selected based upon memory choice information inputted by the design engineer 104.

Next, the first memory device type is selected for further processing, via step 606. For the illustration, assume the following memory choices were inputted: DRAM, Parallel Flash, Serial Flash, and a Serial electrically erasable programmable read-only memory (EEPROM). The DRAM is first selected for further processing, via step 606.

Next, the memory device(s) of the memory device type is selected, via step 608, based upon criteria inputted for this memory device type. For the illustration, assume that technical criteria inputted for the DRAM includes the DRAM type of synchronous DRAM (SRAM), the DRAM performance of PC100/CL3, the DRAM bus width of 32-bits, no ECC/Parity requirement, the maximum megabyte (MB) capacity of 64 MB, the minimum MB capacity of 16 MB, and the desired MB capacity of 32 MB. Inputted market criteria includes lowest cost, most available, and lowest power consumption. Based upon the technical criteria, one or more SDRAM memory devices are selected. Then, from these SDRAM devices, those which address the market criteria are selected. Thus, assume that three SDRAM devices address the technical criteria. Then, a first SDRAM device which has the lowest cost is selected; a second SDRAM device which is the most available is selected; and a third SDRAM device with the lowest power consumption is selected. The first, second, and third selected SDRAM devices may be the same or different devices.

Next, the construction of the multiple memory type module is computed, via step 610, for the memory device type. The construction refers to the number of devices and spaces for the memory device type for each criteria. For the illustration, the number of devices and spaces is computed for the first, second, and third SDRAM memory devices. Thus, a number of the first memory device and spaces are computed for the first SDRAM device which has the lowest cost; a number of the second memory device and spaces are computed for the second SDRAM which is the most available; and a number of the memory device and spaces are computed for the third SDRAM which has the lowest power consumption.

Next, the architecture of the multiple memory type module is computed, via step 612. The architecture is a function of the number of memory devices for each memory device type, the width of each memory device type's data bus, and the data bus widths for individual memory devices. The computed architecture can include the appropriate number of banks and chips selects per memory device type for each criteria. Steps 608 through 612 are repeated for each memory device type, via step 614. In the illustration, steps 608 through 612 are repeated for the Parallel Flash, the Serial Flash, and the Serial EEPROM.

Then, specific multiple memory type modules from the selected family of multiple memory type modules is determined for each market criteria, via step 616. The selected multiple memory type modules have the inputted memory device types, the computed construction, and the computed architecture. These modules are the memory system solutions which address the technical and market criteria inputted by the design engineer 104. If any of the determined multiple memory type modules does not exist in the library 108, via step 618, then a new solution, in the form of a design of the needed multiple memory type module, is created, via step 208. The solutions are then displayed to the design engineer 104 using the user interface 102, via step 210.

Although the present invention is described with the solution extraction described above, one of ordinary skill in the art will understand that other methods may be used to extract solutions without departing from the spirit and scope of the present invention.

An automated memory design system has been disclosed. The automated memory design system receives criteria from a design engineer, which includes technical and market criteria. Based on these criteria, the memory design system returns a set of memory subsystem solutions from which the design engineer may choose. In the preferred embodiment, the solutions are selected from libraries of multiple memory type modules which use a single memory bus. If the solution does not exist in the libraries, a new solution is created. In this manner, the engineering time and resources required in designing the memory subsystem is reduced; a flexible memory system design is provided which addresses software development, obsolescence and market volatility problems; and a memory system design is provided which addresses the custom requirements of many different applications.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a memory system design, comprising the steps of:
(a) receiving memory system criteria; and
(b) automatically extracting at least one memory system design based upon the memory system criteria.

2. The method of claim 1, wherein the receiving step (a) comprises:
(a1) providing a user interface; and
(a2) receiving the memory system criteria via the user interface.

3. The method of claim 1, wherein the memory system criteria comprises:
technical criteria; and
market criteria.

4. The method of claim 1, wherein the automatically extracting step (b) comprises:
(b1) automatically processing the memory system criteria; and
(b2) automatically extracting the at least one memory system design, wherein the at least one memory system design addresses the processed memory system criteria.

5. The method of claim 4, wherein the automatically extracting step (b2) comprises:
(b2i) selecting a library type of multiple memory type modules based upon the memory system criteria;
(b2ii) selecting a family of multiple memory type modules in the library type based upon the memory system criteria;
(b2iii) selecting at least one of a memory device of one of a plurality of memory device types based upon the memory system criteria, wherein the memory system criteria comprises a choice of the plurality of memory device types;
(b2iv) computing a construction for a multiple memory type module for the one of the plurality of memory device types based upon the memory system criteria;
(b2v) computing an architecture for a multiple memory type module for the one of the plurality of memory device types based upon the memory system criteria;
(b2vi) repeating steps (b2iii) through (b2v) for each of the plurality of memory device types; and
(b2vii) determining a multiple memory type module in the family which comprises the plurality of memory type devices, the computed construction, and the computed architecture for each of the memory system criteria.

6. The method of claim 5, further comprising:
(b2viii) creating a design for a new multiple memory type module if the determined multiple memory type module does not exist in at least one library of multiple memory type modules.

7. The method of claim 1, further comprising:
(c) displaying the at least one memory system design.

8. The method of claim 1, wherein the at least one memory system design comprises a multiple memory type module.

9. The method of claim 8, wherein the multiple memory type module is comprised in at least one library, the at least one library comprising a plurality of multiple memory type modules.

10. The method of claim 9, wherein the plurality of multiple memory type modules comprises different combinations of memory types, architectures, data bus widths, banking schemes, or performance and power characteristics.

11. The method of claim 8, wherein the multiple memory type module comprises:
a plurality of memory devices, comprising:
at least one of a first memory device of a first memory type, and
at least one of a second memory device of a second memory type,
wherein a minimum configuration of the plurality of memory devices consists of:
one memory device of the first memory type, and
one or two memory devices of the second memory type; and
a single memory bus coupled to the plurality of memory devices, wherein the single
memory bus provides communication between a processor and the plurality of memory devices.

12. The method of claim 11, wherein neither the first memory device nor the second memory device stores an identification data describing a device composition of the memory module.

13. The method of claim 12, wherein the plurality of memory devices further comprises:
at least one of a third memory device of a third memory type, wherein the third memory device stores the identification data describing the device composition of the memory module.

14. The method of claim 11, wherein the single memory bus comprises:
a primary channel for communicating an operating system data from the plurality of memory devices to the processor;
an identification channel for communicating an identification data from the plurality of memory devices to the processor; and
a programming channel for providing programming and control signals necessary to program at least one of the plurality of memory devices.

15. The method of claim 14, wherein the programming channel comprises:
a dedicated sub-channel; and
one or more dual function sub-channel lines configured to communicate a programming signal to the plurality of memory devices when the single memory bus is in a programming mode, and to communicate a data transfer signal to the plurality of memory devices when the single memory bus operates in a data transfer mode.

16. The method of claim 14, wherein the single memory bus further comprises:
an expansion channel for communicating data between an additional memory device and the processor.

17. A system, comprising:
at least one library of multiple memory type modules, wherein the at least one library comprises:
a single memory bus;
a plurality of multiple memory type modules, wherein each of the plurality of multiple memory-type modules uses the single memory bus to communicate with a processor, wherein each of the plurality of multiple memory type modules comprises at least one of a first memory device of a first memory type and at least one of a second memory device of a second memory type; and
a computer readable medium coupled to the at least one library, wherein the computer readable medium comprises program instructions for automatically providing a memory system design, the instructions for:
(a) receiving memory system criteria, and
(b) automatically extracting at least one memory system design from the at least one library based upon the memory system criteria.

18. The system of claim 17, further comprising:
a user interface coupled to the computer readable medium for receiving the memory system criteria.

19. The system of claim 17, wherein the memory system criteria comprises:
technical criteria; and
market criteria.

20. The system of claim 17, wherein the automatically extracting instruction (b) comprises instructions for:
(b1) automatically processing the memory system criteria; and
(b2) automatically extracting the at least one memory system design from the at least one library, wherein the at least one memory system design address the processed memory system criteria.

21. The system of claim 20, wherein the automatically extracting instruction (b2) comprises instructions for:
(b2i) selecting a library type of multiple memory type modules based upon the memory system criteria;
(b2ii) selecting a family of multiple memory type modules in the library type based upon the memory system criteria;
(b2iii) selecting at least one of a memory device of one of a plurality of memory device types based upon the memory system criteria, wherein the memory system criteria comprises a choice of the plurality of memory device types;
(b2iv) computing a construction for a multiple memory type module for the one of the plurality of memory device types based upon the memory system criteria;
(b2v) computing an architecture for a multiple memory type module for the one of the plurality of memory device types based upon the memory system criteria;
(b2vi) repeating steps (b2iii) through (b2v) for each of the plurality of memory device types; and
(b2vii) determining a multiple memory type module in the family which comprises the plurality of memory type devices, the computed construction, and the computed architecture for each of the memory system criteria.

22. The system of claim 21, further comprising:
(b2viii) creating a design for a new multiple memory type module if the determined multiple memory type module does not exist in at least one library of multiple memory type modules.

23. The system of claim 17, wherein the computer readable medium further comprises the instructions for:
(c) displaying the at least one memory system design.

24. The system of claim 23, wherein the displaying instruction (c) comprises instructions for:
(c1) creating a new memory system design; and
(c2) displaying the new memory system design.

25. The system of claim 17, wherein a minimum configuration of each of the plurality of multiple memory type modules consists of:
one memory device of the first memory type, and
one or two memory devices of the second memory type.

26. The system of claim 25, wherein neither the first memory device nor the second memory device stores an identification data describing a device composition of the memory module.

27. The system of claim 26, wherein the plurality of memory devices further comprises:
at least one of a third memory device of a third memory type, wherein the third memory device stores the identification data describing the device composition of the memory module.

28. The system of claim 17, wherein the plurality of multiple memory type modules comprise different combinations of memory types, architectures, data bus widths, banking schemes, or performance and power characteristics.

29. The system of claim 17, wherein the single memory bus comprises:
a primary channel for communicating an operating system data from one of the plurality of multiple memory type modules to the processor;
an identification channel for communicating an identification data from one of the plurality of multiple memory type modules to the processor; and
a programming channel for providing programming and control signals necessary to program at least one memory device in one of the plurality of multiple memory type modules.

30. The system of claim 29, wherein the programming channel comprises:
a dedicated sub-channel; and
one or more dual function sub-channel lines configured to communicate a programming signal to one of the plurality of multiple memory type modules when the single memory bus is in a programming mode, and to communicate a data transfer signal to one of the plurality of multiple memory type modules when the single memory bus operates in a data transfer mode.

31. The system of claim 29, wherein the single memory bus further comprises:
an expansion channel for communicating data between an additional memory device and the processor.

32. A method for providing a memory system design, comprising the steps of:
(a) receiving memory system criteria;
(b) automatically processing the memory system criteria; and
(c) automatically extracting at least one memory system design, wherein the at least one memory system design comprises a multiple memory type module, wherein the multiple memory type module addresses the processed memory system criteria.

33. The method of claim 32, wherein the receiving step (a) comprises:
(a1) providing a user interface; and
(a2) receiving the memory system criteria via the user interface.

34. The method of claim 32, wherein the memory system criteria comprises:
technical criteria; and
market criteria.

35. The method of claim 32, wherein the multiple memory type module is comprised in at least one library, the at least one library comprising a plurality of multiple memory type modules.

36. The method of claim 35, wherein the plurality of multiple memory type modules comprise different combinations of memory types, architectures, data bus widths, banking schemes, or performance and power characteristics.

37. The method of claim 32, wherein the automatically extracting step (c) comprises:
(c1) selecting a library type of multiple memory type modules based upon the memory system criteria;
(c2) selecting a family of multiple memory type modules in the library type based upon the memory system criteria;
(c3) selecting at least one of a memory device of one of a plurality of memory device types based upon the memory system criteria, wherein the memory system criteria comprises a choice of the plurality of memory device types;
(c4) computing a construction for a multiple memory type module for the one of the plurality of memory device types based upon the memory system criteria;
(c5) computing an architecture for a multiple memory type module for the one of the plurality of memory device types based upon the memory system criteria;
(c6) repeating steps (c3) through (c5) for each of the plurality of memory device types; and
(c7) determining a multiple memory type module in the family which comprises the plurality of memory type devices, the computed construction, and the computed architecture for each of the memory system criteria.

38. The method of claim 37, further comprising:
(c8) creating a design for a new multiple memory type module if the determined multiple memory type module does not exist in at least one library of multiple memory type modules.

39. The method of claim 32, further comprising:
(d) displaying the at least one memory system design.

40. The method of claim 32, wherein the multiple memory type module comprises:
a plurality of memory devices, comprising:
at least one of a first memory device of a first memory type, and
at least one of a second memory device of a second memory type,
wherein a minimum configuration of the plurality of memory devices consists of:
one memory device of the first memory type, and
one or two memory devices of the second memory type; and
a single memory bus coupled to the plurality of memory devices, wherein the single memory bus provides communication between a processor and the plurality of memory devices.

41. The method of claim 40, wherein neither the first memory device nor the second memory device stores an identification data describing a device composition of the memory module.

42. The method of claim 41, wherein the plurality of memory devices further comprises:
at least one of a third memory device of a third memory type, wherein the third memory device stores the identification data describing the device composition of the memory module.

43. The method of claim 40, wherein the single memory bus comprises:
a primary channel for communicating an operating system data from the plurality of memory devices to the processor;
an identification channel for communicating an identification data from the plurality of memory devices to the processor; and
a programming channel for providing programming and control signals necessary to program at least one of the plurality of memory devices.

44. The method of claim 43, wherein the programming channel comprises:
a dedicated sub-channel; and
one or more dual function sub-channel lines configured to communicate a programming signal to the plurality of memory devices when the single memory bus is in a programming mode, and to communicate a data transfer signal to the plurality of memory devices when the single memory bus operates in a data transfer mode.

45. The method of claim 44, wherein the single memory bus further comprises:
an expansion channel for communicating data between an additional memory device and the processor.

46. A computer readable medium with program instructions for providing a memory system design, the instructions for:
(a) receiving memory system criteria; and
(b) automatically extracting at least one memory system design based upon the memory system criteria.

47. The medium of claim 46, wherein the receiving instruction (a) comprises instructions for:
(a1) providing a user interface; and
(a2) receiving the memory system criteria via the user interface.

48. The medium of claim 46, wherein the memory system criteria comprises:
technical criteria; and
market criteria.

49. The medium of claim 46, wherein the automatically extracting instruction (b) comprises instructions for:
(b1) automatically processing the memory system criteria; and
(b2) automatically extracting the at least one memory system design, wherein the at least one memory system design addresses the processed memory system criteria.

50. The medium of claim 49, wherein the automatically extracting instruction (b2) comprises instructions for:
(b2i) selecting a library type of multiple memory type modules based upon the memory system criteria;
(b2ii) selecting a family of multiple memory type modules in the library type based upon the memory system criteria;
(b2iii) selecting at least one of a memory device of one of a plurality of memory device types based upon the memory system criteria, wherein the memory system criteria comprises a choice of the plurality of memory device types;
(b2iv) computing a construction for a multiple memory type module for the one of the plurality of memory device types based upon the memory system criteria;
(b2v) computing an architecture for a multiple memory type module for the one of the plurality of memory device types based upon the memory system criteria;
(b2vi) repeating steps (b2iii) through (b2v) for each of the plurality of memory device types; and
(b2vii) determining a multiple memory type module in the family which comprises the plurality of memory type devices, the computed construction, and the computed architecture for each of the memory system criteria.

51. The medium of claim 50, further comprising instructions for:
(b2viii) creating a design for a new multiple memory type module if the determined multiple memory type module does not exist in at least one library of multiple memory type modules.

52. The medium of claim 46, further comprising instructions for:
(c) displaying the at least one memory system design.
